(19) United States
(12) Patent Application Publication
(10) Pub. No.: US 2009/0045268 A1
(43) Pub. Date: Feb. 19, 2009

(54) Automatic Metered Personal Dispensing System

(76) Inventors: Raymond K. Selander, Hopewell Junction, NY (US); Timothy Lauren, Edison, NJ (US); Daniel A. Juell, Atlantic Highland, NJ (US)

Correspondence Address: INTERNATIONAL FLAVORS & FRAGRANCES INC., 521 WEST 57TH ST, NEW YORK, NY, 10019, US

(21) Appl. No.: 11/840,349

(22) Filed: Aug. 17, 2007

(51) Int. Cl. B05B 7/26

(52) U.S. Cl. 239/310

(57) ABSTRACT

Apparatus and methods for dispensing an additive product through a showerhead are disclosed. In a first aspect of the invention, a system is provided in which a triggering mechanism such as motion detectors sense movement and actuate a valve, which in turn admits an additive product such as soap, shampoo or conditioner into a tube that is in turn connected to the showerhead assembly, which preferably has an internal venturi section into which the additive flows. The additive is mixed and aerated with the water flow and dispensed for a predetermined period of time, and then the valve closes. The motion detectors can also be used to adjust the predetermined period of time the material is dispensed. An improved venturi assembly is also disclosed.

### FIELD OF THE INVENTION

The present invention relates to shower and bath fixtures and more particularly to improved showerheads that dispense soap, shampoo and other additive products directly via the flow of water through the showerhead.

### BACKGROUND OF THE INVENTION

There have been numerous attempts to provide apparatus that will dispense soap, shampoo, hair conditioner or similar additives to a stream of water, either before or after it emanates from a showerhead of a conventional shower bath. For example, U.S. Pat. No. 4,225,085—Headen discloses a showerhead dispenser for bath oil inserted between a shower line and a showerhead. Water pressure forces the bath oil out of a container through a downstream bore or aperture, where it mixes with water enroute to the showerhead.

U.S. Pat. No. 4,293,083—Meares, Jr. discloses a shower dispenser connected to a shower water pipe. The mixing device has a transverse passage that intersects the shower water flow conduit and is in turn connected to U-shaped detachable reservoirs filled with additive to be dispensed.

U.S. Pat. No. 4,607,793—Eberle discloses a showerhead that dispenses liquid additives into the water flow by drawing the additives from containers connected through a supply line to a manually operated valve. The valve selectively connects each supply line with an aspirating conduit that communicates with the passage in the shower.

U.S. Pat. No. 4,200,206—Chase, et al. and 4,189,100—Karp both disclose shower attachable dispensers that position a reservoir of additive above the showerhead and flow the additive through conduits by gravity.

U.S. Pat. Nos. 4,131,232—Pollinzi and 4,921,171—Cupit both disclose an automatic shower dispenser attachable to the water inlet pipe of a shower head that includes a plastic refillable container for holding the liquid additive and dispensing it under the flow of gravity in front of the shower head.

However, none of the designs set forth above has achieved widespread adoption. The majority of shower users today use bars of soap or liquid soap, along with bottles of liquid shampoo and conditioner. Simple, manually pumped wall-mounted dispensers for liquid products are also known, but are also not in widespread use. Because of the potential for efficiency of use of additive products and water, as well as sanitary aspects and reduction of clutter, there remains a long-felt yet still unsolved need to deliver soap, shampoo or other additives directly into the shower stream.

### SUMMARY OF THE INVENTION

These and other shortcomings of the prior art have now been overcome by apparatus for dispensing additive products into a showerhead that is connected to a water conduit and has a mixing section such as a venturi assembly connecting the water conduit and the showerhead. In accordance with the present invention, there is at least one vessel containing at least one additive product and an electronically controlled valve that is controlled by a triggering mechanism such as a motion detector, so that the valve can be opened without touching the apparatus. A feed tube connecting the vessel to an input of the valve and a dispenser line connecting an output of the valve to the mixing section, preferably a venturi assembly, deliver the additive product so that activation of the triggering mechanism opens the valve for a predetermined time to dispense an additive product into the venturi and the valve then closes. In preferred embodiments, the vessel is affixed to the water conduit, and in other embodiments it is affixed to a wall. In other preferred embodiments, a second vessel is added that contains a second additive product, along with a second motion detector respectively controlling flow from the second vessel. In operation, the motion detector senses a first event and sends a signal setting the duration of the predetermined time, and the motion detector thereafter detects a second event and thereafter opens the valve for a predetermined time. Typically, the predetermined time is between 3 seconds and 30 seconds. Certain preferred embodiments also include indicators related to the predetermined time and the status of the apparatus, while others permit immediate shut off of the additive flow by a second activation of the triggering mechanism. In certain embodiments, the feed tube has an aperture for admitting air to an interior portion of the feed tube

The present invention also relates to methods of dispensing at least one additive product into a showerhead comprising the steps of activating a triggering mechanism, such as a motion sensor, to set a predetermined period of dispensing, activating a triggering mechanism, such as a motion sensor, to open a valve disposed between the showerhead and a vessel containing the additive product, leaving the valve open for a predetermined period, and then closing the valve. In operation, a solution containing the additive product is delivered through the showerhead. In preferred embodiments, additional steps of activating a second triggering mechanism, such as a motion sensor, to set a predetermined period of dispensing, activating a second triggering mechanism, such as a motion sensor, to open a valve disposed between the showerhead and a second vessel containing the second additive product, leaving the valve open for a predetermined period and closing the valve, are carried out so that as a result a solution containing the second additive product is delivered through the showerhead. Preferably, the step of activating a triggering mechanism, such as a motion sensor, to set a predetermined period of dispensing further comprises activating an indicator light.

In certain embodiments, the valve is pulsed between and open and a closed position to create an intermittent flow of the additive product. In other embodiments, the steps of activating a triggering mechanism, such as a motion sensor, preferably comprise moving a hand in the vicinity of the sensor, and certain embodiments delay the opening of the valve for a predetermined period. Finally, in certain embodiments the additive product is aerated prior to its introduction into the showerhead.

In another aspect the present invention also relates to apparatus for dispensing at least one additive product into a showerhead comprising a water conduit and a venturi assembly connecting the water conduit and the showerhead, the venturi assembly comprising a nipple and a venturi insert disposed within the nipple, said venturi insert having a central bore of a first diameter. There is at least one vessel containing at least one additive product and a feed tube connecting the vessel to the venturi assembly. In accordance with this aspect of the invention, the feed tube has a diameter slightly smaller than the first diameter and is disposed within the central bore of the venturi insert. An agitator extending across the central bore at a distal end of the venturi insert is added in certain embodiments.

### BRIEF DESCRIPTION OF THE DRAWINGS

A more detailed understanding of the invention may be derived from the following description, given by way of example and to be understood in conduction with the accompanying drawings, wherein like elements are designated by like numerals, and wherein:

FIG. 1 is a perspective view of a showerhead made in accordance with a preferred embodiment of the present invention;

FIG. 2 is an exploded elevation view of the showerhead illustrated in FIG. 1;

FIG. 3 is an exploded perspective view of the showerhead illustrated in FIG. 1;

FIG. 4 is a cut away elevation view of the showerhead illustrated in FIG. 1;

FIG. 5 is a cross-sectional view of a portion of the showerhead shown in FIG. 4;

FIG. 6 is a perspective view of a product dispenser line used in conjunction with a preferred embodiment of the present invention;

FIG. 7 is a diagrammatic illustration of an automated product dispenser assembly made in accordance with the present invention; and

FIG. 8 is a diagrammatic illustration of another embodiment of an automated product dispenser assembly made in accordance with the present invention.

### DETAILED DESCRIPTION OF THE PREFERRED EMBODIMENTS

Although the features and elements of the present invention are described in the preferred embodiments in particular combinations, each feature or element can be used alone (without the other features and elements of the preferred embodiments) or in various combinations with or without other features and elements of the present invention.

The embodiments of the present invention may be implemented with any combination products dispensed, although particularly adapted for showers that cleanse a person, the system is useful for showers used to disinfect or industrial and laboratory showers that neutralize chemical exposure or remove contaminants by mixing a product with liquid dispensed via one or more shower heads or similar nozzles. Therefore, as used herein, a term such as “product” or “additive” is meant to be inclusive of any and all types of products dispensed in a shower. Similarly, the use of a term such as “gel” or “soap” or “shampoo” is used for purposes of illustration and is not limiting.

The system of the present invention provides a unique delivery of one or more additive products while showering and allows the consumer or user of the shower a higher degree of control in terms of dispensing the additive products, most preferably without touching a control device. This feature enhances the functional aspects of taking a shower as well as providing an improved user experience.

The basic components of the device are an electronics module, one or more reservoirs, tubing and a manifold, a venturi for viscous material and a showerhead. The present invention provides a device that has a touch free activation that results in the uniform delivery of a product such as shower gel, shampoo or similar products used while using a shower. In use, the present invention provides a system that quickly and uniformly covers the body parts in the shower spray, resulting in timesavings while maintaining water temperature and other factors related to comfort.

Referring now to FIG. 1 a perspective view of a showerhead 50 is illustrated. The showerhead 50 is conventional and includes a diffuser 52, which emits a spray and a coupling nut 56 that connects the showerhead 50 to a shower supply line using conventional connections, such as a threaded coupling. Typically, the coupling nut 56 is connected directly to a mating coupler 54; however, in accordance with the present invention and as explained more fully below, a venturi assembly 100 is disposed between the coupler 54 and the coupling nut 56. As seen in FIG. 1, the venture assembly includes a nipple 102 (typically 0.50 inches) and a product dispenser line 104, which, as explained below are connected to a source of soap or similar material that is to be added to the shower water.

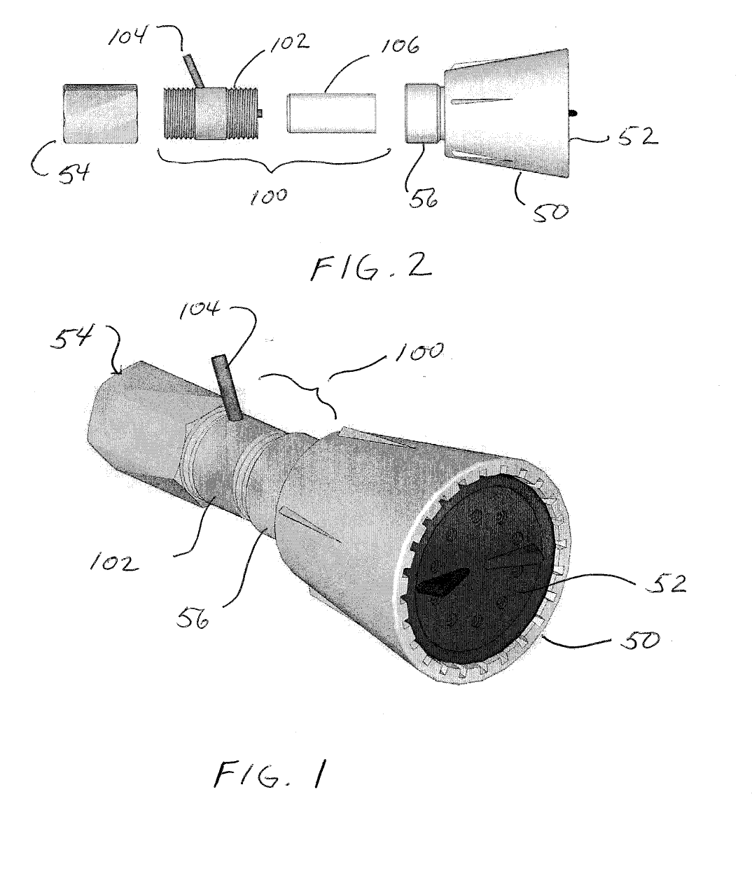

Further details of the venturi assembly 100 can be seen in FIG. 2, which is an exploded elevation view of the showerhead 50 illustrated in FIG. 1. As explained above, the venturi assembly 100 is disposed between the showerhead 50 and the showerhead coupler 54, and is preferably comprised of a nipple 102, that is threaded or otherwise adapted to connect the showerhead 50 and the coupler 54 that connects to a water source. The nipple 102 also includes the product dispenser line 104, which passes through the wall of the nipple to provide a conduit for the admission of soap or a similar material, as explained below. Typically but not necessarily, the nipple 102 and product dispenser line 104 will be made from similar materials, e.g., copper or brass, or can be molded or cast as one part, or can be made of different materials, so long as they are not dissimilar, i.e., it would be preferred the components do not corrode or disintegrate upon exposure to water, soap, and the like. The venturi insert 106 is sized to slide within the nipple 104 as explained in further detail below. The insert is preferably made from Delrin™ or other dimensionally stable material, whether plastics material, metal or a composite. As will be appreciated from the description below, it will be desirable to machine or form the venturi insert 106 within tight dimensional tolerances, which will be one of the factors in choosing a suitable material.

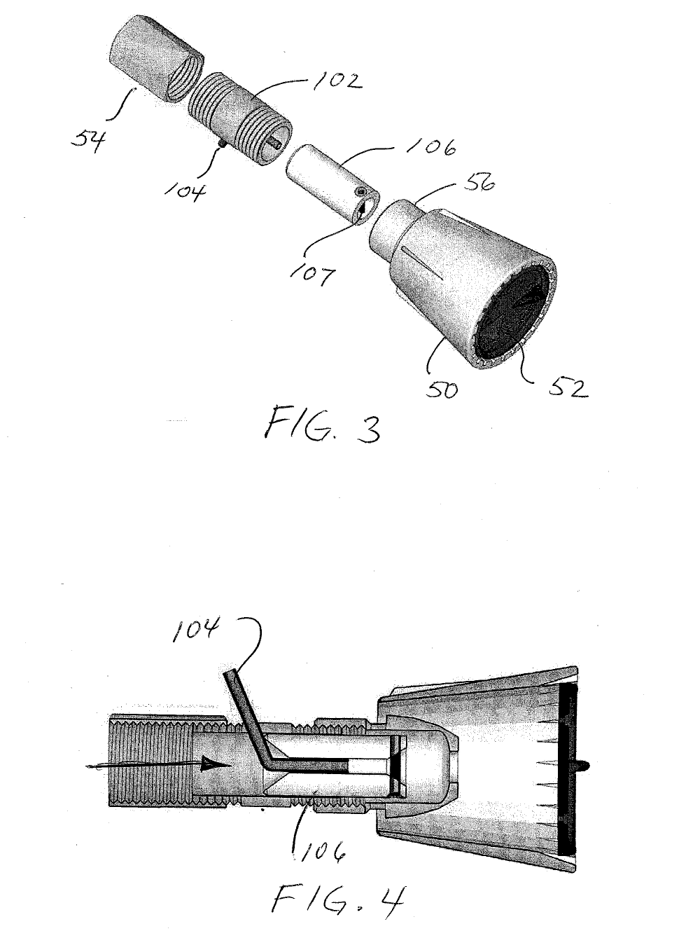

FIG. 3 is an exploded perspective view of the showerhead illustrated in FIG. 1. In this view, it can be seen that the product dispenser line 104 passes through the wall of the nipple 102 and bends so that the conduit is centered approximately at the axis of the nipple, and thereby, upon assembly, centered within the venturi insert 106. In certain preferred embodiments, an agitator such as a setscrew 107 is provided to partially block the exit from the venturi, as explained in further detail below. The agitator can be any stricture extending into or across the bore, and can either be an additional element or molded or otherwise integral with the venturi insert 106.

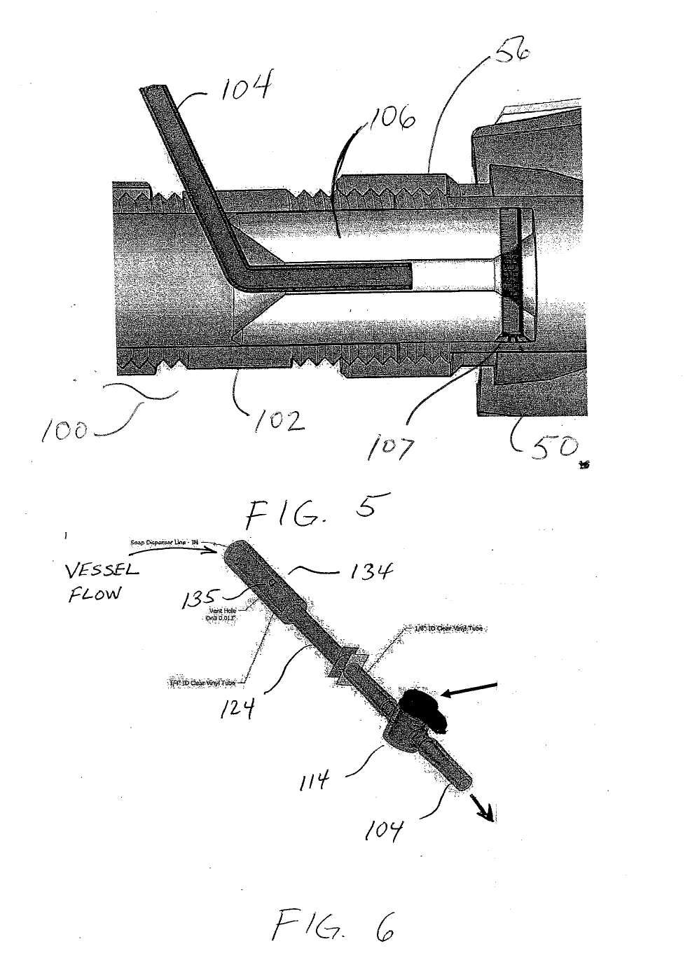

Further details of the assembly described above can be seen in FIG. 4, which is a cut away elevation view of the showerhead illustrated in FIG. 1. In this view, the relative placement of the components in a preferred embodiment is better observed. The product dispenser line 104 enters through the wall of the nipple 102 at a slight angle, chosen to ensure smooth flow of the additive product being delivered via the dispenser line 104. The dispenser line 104 is disposed within the central orifice of the venturi insert 106. As will be understood by those of skill in the art, the venturi insert 106 will have a proximal end on the upstream side of the flow of water (shown by the arrow), and the proximal end will be generally conically-shaped and taper to a significantly smaller diameter, thereby increasing the velocity of the flow. After transit through a relatively cylindrical section (in which the dispenser line 104 is disposed) the flow will exit the distal end of the venturi insert 106. The distal end is also somewhat flared or in the shape of a truncated cone, but typically of different dimensions that the “upstream” section of the venturi.

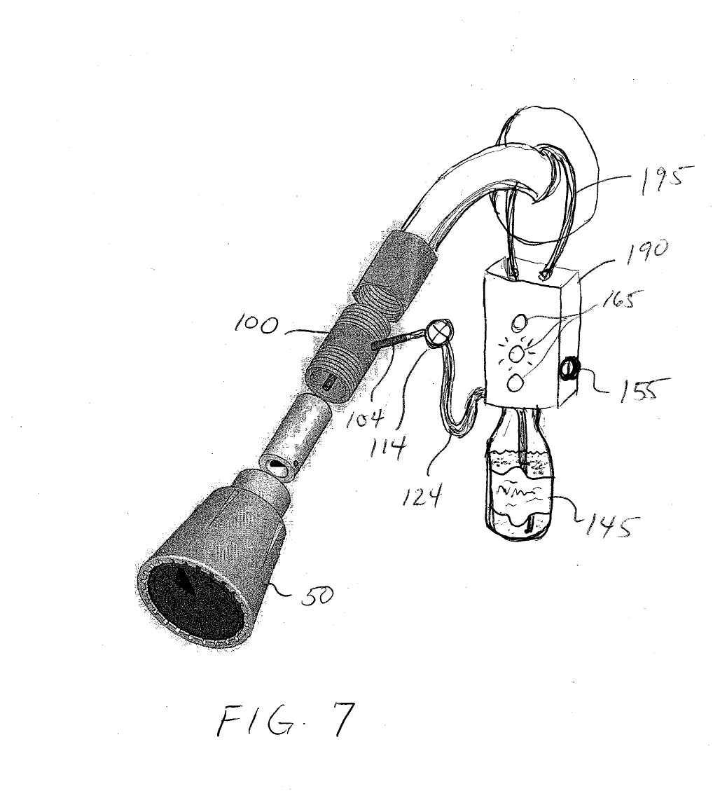

Further details of the relative dimensions of the preferred embodiment are seen in FIG. 5, which is a cross-sectional view of a portion of the showerhead shown in FIG. 4. As explained in further detail below and seen in FIG. 5, there is an annular clearance space between the outer wall of the dispenser line 104 and the diameter of the central bore of the venturi insert 106. Near the distal end, across the conical section, the agitator, such as the setscrew 107 described above cuts transversely across the diameter of the venturi insert 106. In the preferred embodiment illustrated, the shower head is preferably specially adapted to utilize the Venturi effect and create sufficient pressure differential to “lift” or draw the often viscous product through the tube.

As noted above, in a preferred embodiment, the dispenser line is comprised of tubing having and outer diameter of 0.125 inches (⅛″ O/D) and the venturi insert is bored to 11/64″ leaving a small cross-sectional annular space. This aspect of the design is a departure from a true “venturi” system, which typically does not place an obstruction within the central bore to interfere with the flow, rather, it just ‘taps’ into the flow where the flow rate is ‘choked,’ because the velocity is higher there, and thus, the pressure is lower, resulting in a negative pressure differential relative to atmosphere. The generalized fluid dynamics of the Venturi effect are well known and well-characterized. The Venturi effect is a special case of Bernoulli's principle, which recognizes that any increase in fluid velocity along a streamline is accompanied by a drop in pressure. Empirical observation has shown that the design illustrated herein is effective, and the relatively high restriction created by the small effective area of the central bore through the venturi insert 106 maintains back-pressure much higher than a free flowing system would. Moreover, the area of this annular cross-section is preferably slightly greater in area than the orifice found in typical showerheads. In the example set forth in detail above, the cross-sectional area for flow, through the venturi insert 106, is 0.0109 square inches, while the cross-sectional area of the orifice in a typical shower head is only 0.0069″ (i.e., the area of 3/32″ orifice). What this means is that the original showerhead, before the addition of the present invention had a smaller diameter restriction for the water entering the showerhead. Thus, in the preferred embodiment illustrated and described, the resulting showerhead is less restrictive than that which is typically employed, meaning that the total flow of water is increased.

The venturi design disclosed herein is based on empirical observation experiment. A mechanical engineer with knowledge of venturi systems could optimize a venturi design based on both the types of additives and their fluid properties such as viscosity, along with other variables such as typical water system pressures, temperature and desired showerhead flow in terms of both pressure and velocity. The precise design of a specific venturi system, although an important part of the invention, is readily determined by a person of skill in the art and is not otherwise unique. In terms of the present invention, the venturi section 106 functions to introduce bath soap, shampoo or other additives into the water stream. In alternate embodiments, a pump can be used to deliver additives into shower water source line, instead of venturi suction feed.

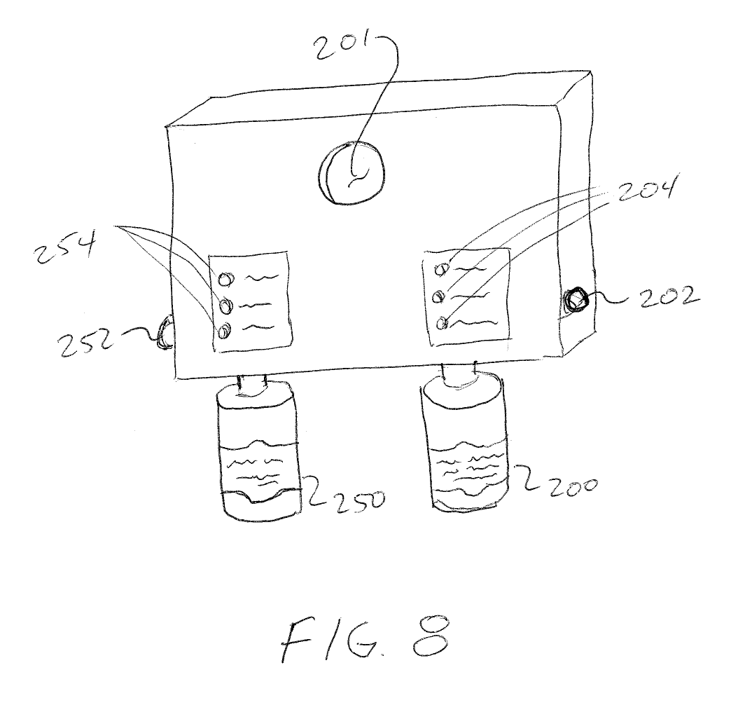

Additional details of the system of the present invention are illustrated in FIG. 6, which is a perspective view of a product dispenser line used in conjunction with a preferred embodiment of the present invention. As described above, the dispenser line 104 extends from the venturi assembly 100 and is connected to a valve 114 that regulates the addition of an additive to the stream of water in the venturi assembly 100. As explained in detail below, the valve 114 is electrically operated and moves between a closed and an open position for a pre-determined amount of time. The valve 114 is connected in turn to a feed tube 124 that carries the additive product. In certain embodiments, the feed tube 124 is connected to a vessel containing the additive product, however, in the preferred embodiment illustrated, the feed tube 124 is in turn connected at its proximal end to a dispenser connector 134 that preferably includes a vent hole 135. The structure of the vessel and the function of the vent hole 135 are discussed below with reference to FIGS. 7 and 8. The vessel may be attached to the water conduit of the shower, the venturi assembly 100, or to a wall or other adjacent structure, such as faucet handles and the like.

FIG. 7 is a diagrammatic illustration of an automated product dispenser assembly made in accordance with the present invention. A showerhead 50 is connected to a valve 114 that is in turn connected to a vessel 145. A sensor assembly 155, the details of which are explained below, controls the valve. In this single product embodiment, as with other embodiments, by activating a triggering mechanism, such as a motion sensor, 155, a signal is sent (via a wire running the length of the feed tube 124) to open the valve 114 and thus permit flow of the product from the vessel 145 through the venturi assembly 100 so that an aerated mixture of product and water is delivered via the showerhead 50. As described in further detail below, indicator lights 165 are provided in preferred embodiments to show the user that the system is activated and to indicated which of several “dosings” can be selected. Varying the duration of the time the valve 114 is open typically carries out the variation in the dosings. As will be understood by those skilled in the art, the system described herein needs to be enclosed in a housing 190, and, as illustrated, the housing 190 can be mounted using a simple hanger 195, although any structurally acceptable technique can be employed, examples being suction cups, adhesive strips and other mechanical mounts that utilize faucets or other structures available within the shower.

FIG. 8 is a diagrammatic illustration of another embodiment of an automated product dispenser assembly made in accordance with the present invention. In this embodiment, a first product container 200 as described above is paired with a second product container 250. As illustrated, the containers are disposed along either side of the shower tube, using hanger hole 201 and can be constructed as part of a unit that includes the venturi assembly 100 described above, or may be a separate structure, such as a plastic shell that clamps around the venturi assembly 100. Each product container 200,250 is provided with adjacent triggering mechanisms, such as motion sensors 202,252, which may either detect motion or simply proximity, but in any embodiment generate an appropriate triggering signal. Alternatively, directly wired push button, toggle and rotary switches can be used in place of the motion sensors 202,252 to accomplish the triggering mechanism function. As explained above, the triggering mechanisms, such as motion sensors 202,252 are employed so that the dispensing cycle is initiated without touching the device. The product containers are each connected to the venturi assembly 100 as described above using dispenser lines 102 (not seen in FIG. 8). As explained above, a valve 114 regulates the admission of the product from the container into the dispenser line(s) 102. In the preferred embodiment illustrated, providing sets of dose amount selectors 204,254 that also preferably serve as dose amount indicators further enhances the device. The function of the dose amount selectors 204,254 is to allow the user to select the length of time the product is dispensed into the dispenser line(s) 102.

In operation a user initiates a shower in a conventional manner and creates the desired water temperature. The user then moves a body part under a sensor, typically a hand, but a foot or the top of the head could also be employed. The motion beneath the sensor initiates delivery of a first product, such as a shower gel (i.e., soap) by opening a valve disposed proximal to the shower head so that the product is mixed with water and air, and dispersed through the shower head for a pre-determined period of time, e.g., 15 seconds or 30 seconds. The aeration of the product and water is preferably accomplished by admitting air into the suction line connected to the reservoir, which is itself vented to the atmosphere to equalize pressure and permit the product in the reservoir to be evacuated. In a preferred embodiment a 0.012 diameter hole is created in the dispenser line 104. The reservoir 200,250 is similarly vented to the atmosphere to equalize the pressure. The combination of this hole and the agitator, which is preferably the setscrew 107 described above creates a bubbling, turbulent delivery of a water/product mixture.

An additional advantage provided in certain embodiments is that a unique cap on the reservoir acts as a barrier to tampering and replacement with inferior, adulterated or diluted product. This is a particular advantage in schools where tampering and vandalism are concerns and in hospitals where effectiveness of disinfectants and anti-bacterial products is paramount.

The present invention replaces or augments existing shower heads and is preferably and typically installed using the threaded connection between the showerhead and the shower tube. As illustrated, an extension tube is interposed between the showerhead and the shower tube. Preferably, and as illustrated, a control assembly is part of the extension tube, although the control assembly can be readily adapted to be mounted elsewhere. In the preferred embodiment, by mounting the control assembly in the manner illustrated, the need of a separate mounting bracket or the like is eliminated, and the distance between the reservoirs of product and the extension tube is minimized. This is a useful advantage since the product is typically highly viscous and by minimizing the distance it travels, the efficiency of distribution is optimized. Additionally, minimizing the distance virtually eliminates leftover or waste product remaining in a connecting conduit, which is important in settings where there might be a switch from one type of product to another, e.g., men's fragrance to a women's fragrance, or in a hospital setting from conventional soap to more caustic anti-bacterial scrubs.

In a most preferred embodiment, the system includes at least the electronics for the triggering mechanism, such as a motion sensor, and utilizes batteries to power this function, although ambient light may in some instances be sufficient for photocells to effectively power the motion detector, particularly if the detectors themselves are photocells. The motion detector triggers the delivery of the product by opening a valve for a pre-determined time. A conventional electronic circuit, microprocessor, or an Application Specific Integrated Circuit (ASIC) can be employed to carry out the functions described. The valve permits the product to flow to the showerhead due the pressure differential created by the flow of water and air in the shower tube adjacent the tube. In a most preferred embodiment, lighted indicators, such as LEDs, verify that product is being admitted into the shower and in those embodiments where more than one product is in use, also indicate which product is being dispensed. If desired, additional indicators can be used to provide information, such as which of several dispenser selections has been chosen. For example, a “dispenser selection” can be how much product is dispensed for how long, of it there is a lather/rinse/repeat cycle, which stage of the cycle is currently underway. Additionally, in certain embodiments, a delay for a pre-selected period of time (for example, 3 seconds) prior to the initiation of the dispensing cycle can be added. In other embodiments, the controls incorporate the ability for a second triggering of the motion sensor to cease the release of additive. In other words, a first swipe by the user would start the additive release by activating the triggering mechanism, and if the user wanted to stop the flow, either before the predetermined time was up or in cases where no predetermined time is set, then the flow of additive is stopped with a second activation of the triggering mechanism.

Those of skill in the art will appreciate that the system described herein can be programmed to provide a wide variety of dispensing options. For example, the user could initiate dispensing from the first container 200, by selecting (or observing an indicator) the amount (“dose”) of material to be dispensed. Preferably, this is accomplished by a first pass of the hands (or other body part or an object) to activate the motion detector 202. In this aspect of the invention, the motion detector 202 does not initially operate the valve, but instead cycles the indicator lights 204 until the desired “dose” is indicated using LED indicator lights. A second pass through the field of view of the motion detector will then result in the initiation of a dispensing cycle using the correct duration chosen during the first pass. For example, the duration time over which the product is dispensed can be 8 seconds, 12 seconds and 15 seconds, respectively, with a three second delay between the activation of the triggering mechanism, such as a motion sensor, and the initiation of the dispensing cycle. In various embodiments, the delivery during the time period can be continuous or intermittent (i.e., “pulsed”) for example, over the course of a “middle” setting of 12 seconds, there could be two 5 second pulses separated by a 2 second pause.

In other preferred embodiments, a remote control system using Infrared (IR) transmission and detection, or Radio Frequency (RF) transmission and detection is incorporated into the system of the present invention. Remote control operations preferably include selection of a particular additive, metering the time period, and mixture percentage (e.g., 30 percent is selected by a remote device, which in turn signals the microprocessor to turn the valve on and off repeatedly, for example in a cycle with the valve open 0.3 seconds and off 0.7 seconds). A benefit of activating and programming the system is that if the motion detector triggering the device is placed out of reach, the system is less likely to be triggered by a child.

In preferred embodiments, the electronic controls described above will use a programmable microprocessor that will permit altering the duration of the dispensing cycle so that different units may be programmed to meet market needs. For example, a shampoo/conditioner set of products might be found to have different cycles than a body wash and skin softener treatment. In any such particular combinations, however, if the cycles are pre-determined and there is sufficient demand, a custom ASIC can be employed. In any embodiment, whether a conventional circuit or ASIC, the device may be operated by batteries of photovoltaic cells. It is also feasible to place an impeller in the water stream proximal to the venturi inlet and create a small turbine that in turn operates an internal electric generator that can generate current to recharge storage cells.

Although specific embodiments have been discussed above with reference to a single product dispenser or dual dispensers, it will be understood that although there are practical size and weight limitations, the present invention is useful with three, four or more dispenser bottles arrayed around a single venturi/showerhead combination.

Another alternate embodiment of the present invention integrates the venturi and sensors described above into a sink for washing either hands or dishes.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. Apparatus for dispensing at least one additive product into a showerhead comprising:
a water conduit;
a mixing assembly connecting the water conduit and the showerhead;
at least one vessel containing at least one additive product an electronic control system comprising an electronically controlled valve;
a triggering mechanism operatively associated with the valve;
a feed tube connecting the vessel to an input of the valve; and
a dispenser line connecting an output of the valve to the mixing assembly,
whereby an activation of the triggering mechanism opens the valve for a predetermined time to dispense an additive product into the venturi and the valve then closes.

2. The apparatus of claim 1, wherein the mixing assembly is a venturi.

3. The apparatus of claim 1, wherein the triggering mechanism is a motion detector.

4. The apparatus of claim 1, comprising a first vessel and a second vessel, wherein the first vessel contains a first additive product and the second vessel contains a second additive product.

5. The apparatus of claim 3 further comprising a first motion detector and a second motion detector respectively controlling flow from the first vessel and the second vessel.

6. The apparatus of claim 1, wherein the predetermined time is between 3 seconds and 30 seconds.

7. The apparatus of claim 1, wherein the motion detector senses a first event and sends a signal setting the duration of the predetermined time, and the motion detector thereafter detects a second event and thereafter opens the valve for a predetermined time.

8. The apparatus of claim 7, further comprising indicators related to the predetermined time and the status of the apparatus.

9. The apparatus of claim 1 wherein the dispenser line is disposed within a central bore of the mixing assembly.

10. The apparatus of claim 1 wherein the feed tube comprises an aperture for admitting air to an interior portion of the feed tube

11. A method of dispensing at least one additive product into a showerhead comprising the steps of:
activating a motion sensor to set a predetermined period of dispensing;
activating a motion sensor to open a valve disposed between the showerhead and a vessel containing the additive product;
leaving the valve open for a predetermined period; and
closing the valve,
whereby a solution containing the additive product is delivered through the showerhead.

12. The method of claim 11 further comprising the steps of:
activating a second motion sensor to set a predetermined period of dispensing;
activating a second motion sensor to open a valve disposed between the showerhead and a second vessel containing the second additive product;
leaving the valve open for a predetermined period; and
closing the valve,
whereby a solution containing the second additive product is delivered through the showerhead.

13. The method of claim 11 further comprising the step of pulsing the valve between and open and a closed position to create an intermittent flow of the additive product.

14. The method of claim 11 further comprising the step of activating a motion sensor a second time to cease the flow of additive product.

15. The method of claim 11 further comprising the step of delaying the opening of the valve for a predetermined period.

16. The method of claim 11 further comprising the step of aerating the additive product prior to its introduction into the showerhead.

17. The method of claim 11 wherein the step of activating a motion sensor to set a predetermined period of dispensing further comprises activating an indicator light.

18. Apparatus for dispensing at least one additive product into a showerhead comprising:
a water conduit;
a venturi assembly connecting the water conduit and the showerhead, the venturi assembly comprising a nipple and a venturi insert disposed within the nipple, said venturi insert having a central bore of a first diameter;
at least one vessel containing at least one additive product a feed tube connecting the vessel to the venturi assembly, said feed tube having a diameter slightly smaller than the first diameter and said feed tube disposed within the central bore of the venturi insert.

19. The apparatus of claim 18 further comprising an agitator extending across the central bore at a distal end of the venturi insert.

20. The apparatus of claim 18 wherein the first diameter is 3/32 inches and the second diameter is 1/16 inches.
